(19) United States
(12) Patent Application Publication
(10) Pub. No.: US 2026/0265554 A1
(43) Pub. Date: Sep. 10, 2026

(54) Sublimation Dye Ink Jet Black Ink Composition And Recording Method

(71) Applicant: SEIKO EPSON CORPORATION, Tokyo (JP)

(72) Inventor: Yuta ASAKAWA, Azumino (JP)

(21) Appl. No.: 19/556,576

(22) Filed: Mar. 4, 2026

(30) Foreign Application Priority Data
Mar. 5, 2025 (JP) 2025-034491

(51) Int. Cl. C09D 11/328; C09D 11/037; C09D 11/38; D06P 3/52; D06P 5/28; D06P 5/30

(52) U.S. Cl. CPC C09D 11/328; C09D 11/037; C09D 11/38; D06P 3/52; D06P 5/004; D06P 5/30

(57) ABSTRACT

Provided is a sublimation dye ink jet black ink composition containing a sublimation dye, a humectant, and water, in which the sublimation dye includes a blue-based sublimation dye, a red-based sublimation dye, and a yellow-based sublimation dye, and the blue-based sublimation dye includes a sublimation dye represented by Formula (1) and a sublimation dye represented by Formula (2).

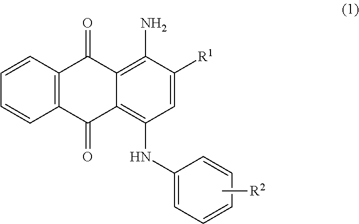

(In Formula (1), R¹ represents H or CH₃, and R² represents H or CH₃.)

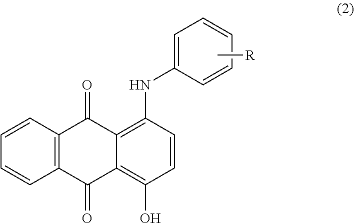

(In Formula (2), R represents H or CH₃.)

The present application is based on, and claims priority from JP Application Serial Number 2025-034491, filed Mar. 5, 2025, the disclosure of which is hereby incorporated by reference herein in its entirety.

### BACKGROUND

### 1. Technical Field

The present disclosure relates to a sublimation dye ink jet black ink composition and a recording method.

### 2. Related Art

The ink jet recording method is a method in which small droplets of an ink are ejected from a fine nozzle and deposited onto a recording medium to perform recording. This method is characterized in that a high-resolution and high-quality image can be recorded at high speed with a relatively inexpensive apparatus. In addition, the ink jet recording method has also been used to dye (print) fabrics and the like.

As a recording method, there is a recording method using an ink containing a sublimation dye. In the case of forming a black image with an ink containing a sublimation dye, the hue may be adjusted to black by mixing a red-based sublimation dye, a yellow-based sublimation dye, and a blue-based sublimation dye. For example, JP-A-2015-093956 discloses a black ink composition containing C.I. Disperse Blue 72 or C.I. Disperse Blue 359 and C.I. Disperse Orange 25 or C.I. Disperse Yellow 54.

However, in a black ink using C.I. Disperse Blue 72, the blueness may be insufficient, causing a reddish tint in the black image, while in a black ink using C.I. Disperse Blue 359, the blueness may be strong, causing a bluish tint in the black image. Therefore, there is a demand for a sublimation dye ink jet black ink composition from which a black image with an excellent hue can be obtained.

### SUMMARY

A sublimation dye ink jet black ink composition according to an aspect of the present disclosure contains a sublimation dye, a humectant, and water. The sublimation dye includes a blue-based sublimation dye, a red-based sublimation dye, and a yellow-based sublimation dye. The blue-based sublimation dye includes a sublimation dye represented by Formula (1) and a sublimation dye represented by Formula (2).

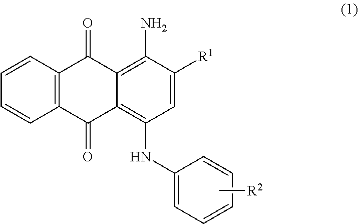

(In the above Formula (1), R¹ represents H or CH₃, and R² represents H or CH₃.)

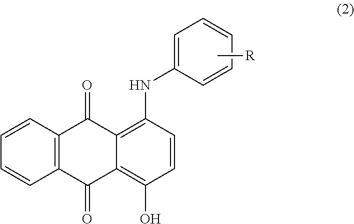

(In the above Formula (2), R represents H or CH₃.)

A recording method according to an aspect of the present disclosure includes ejecting the sublimation dye ink jet black ink composition described above from an ink jet head and depositing the sublimation dye ink jet black ink composition onto a recording medium.

### BRIEF DESCRIPTION OF THE DRAWINGS

FIG. 1 is a perspective view of an example of a recording apparatus.

FIG. 2 is Table 1 showing the composition and the like of the compositions used in examples.

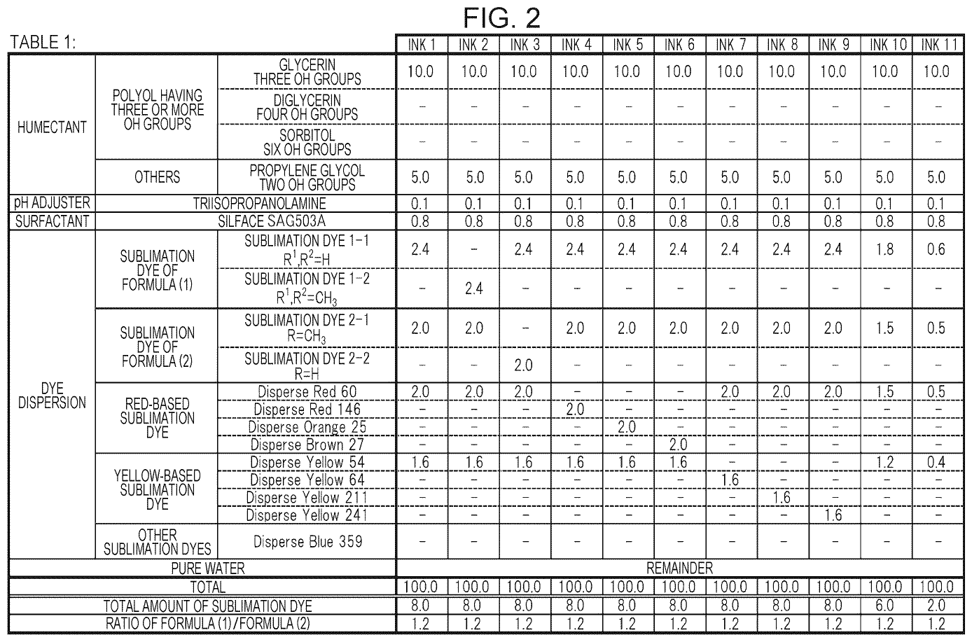

FIG. 3 is Table 2 showing the composition and the like of the compositions used in examples and comparative examples.

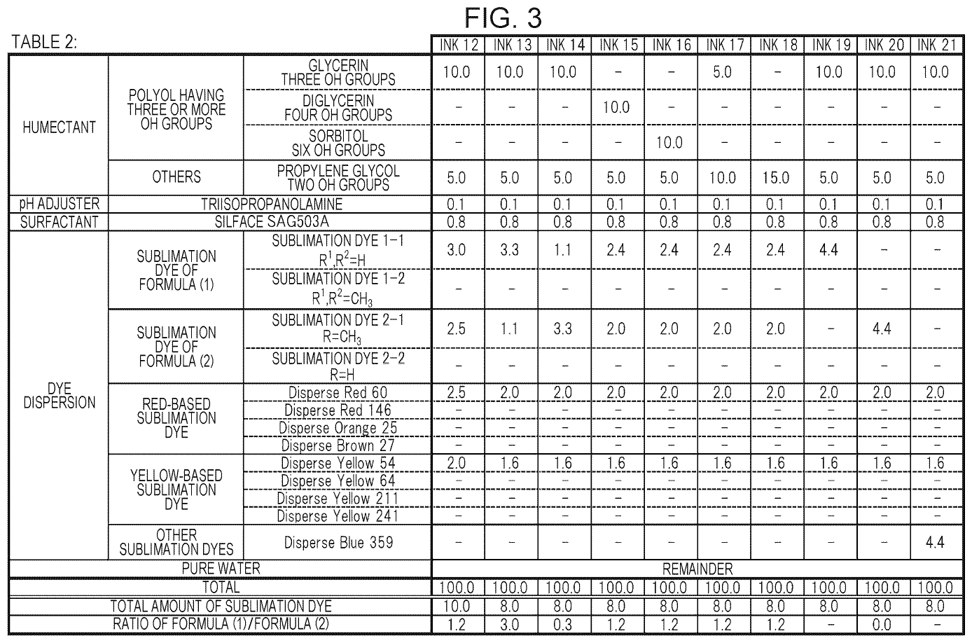

FIG. 4 is Table 3 showing the evaluation results of the examples and comparative examples.

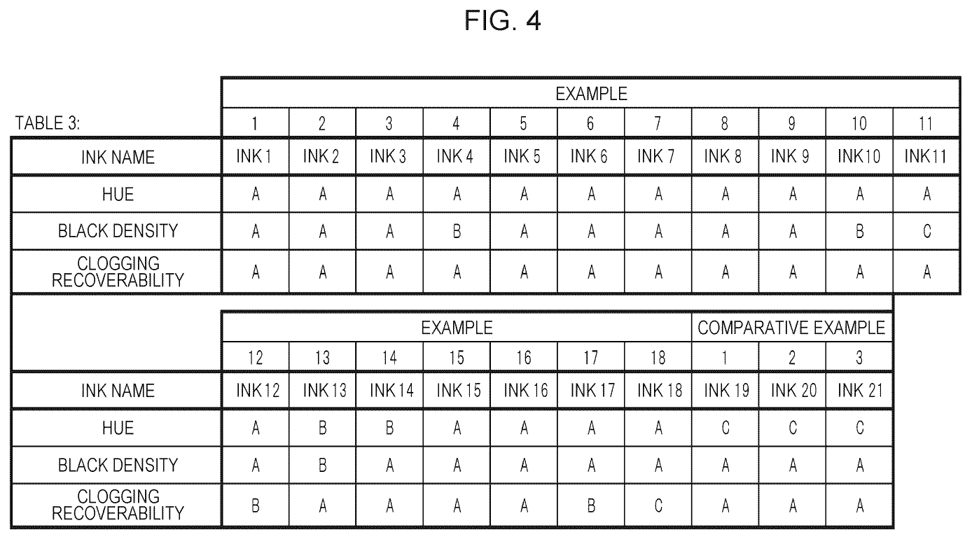

### DESCRIPTION OF EMBODIMENTS

Hereinafter, embodiments of the present disclosure will be described. The embodiments described below illustrate examples of the present disclosure. The present disclosure is not limited to the following embodiments, and includes various modifications implemented within a range not changing the gist of the present disclosure. Not all of the configurations described below are configurations essential to the present disclosure.

### 1. Sublimation Dye Ink Jet Black Ink Composition

A sublimation dye ink jet black ink composition according to the present embodiment contains a sublimation dye, a humectant, and water. The sublimation dye includes a blue-based sublimation dye, a red-based sublimation dye, and a yellow-based sublimation dye, and the blue-based sublimation dye includes a sublimation dye represented by Formula (1) and a sublimation dye represented by Formula (2).

### 1.1. Sublimation Dye

The sublimation dye ink jet black ink composition according to the present embodiment contains a sublimation dye. The sublimation dye includes a blue-based sublimation dye, a red-based sublimation dye, and a yellow-based sublimation dye. The term “sublimation dye” refers to a disperse dye or solvent dye having a molecular weight of 500 or less.

In addition, the blue-based sublimation dye, the red-based sublimation dye, and the yellow-based sublimation dye as used herein are as follows.

A blue-based sublimation dye refers to a dye whose hue angle ∠H°, as defined in the CIELAB color space on a printed article after printing, is within a range of 225° or more and less than 315°. In addition, a red-based sublimation dye refers to a dye whose hue angle ∠H°, as defined in the CIELAB color space on a printed article after printing, is within a range of 315° or more and less than 360° or within a range of 0° or more and less than 90°. Further, a yellow-based sublimation dye refers to a dye whose hue angle ∠H°, as defined in the CIELAB color space on a printed article after printing, is within a range of 90° or more and less than 135°.

### 1.1.1. Blue-Based Sublimation Dye

The sublimation dye includes a blue-based sublimation dye. The blue-based sublimation dye includes a sublimation dye represented by Formula (1) and a sublimation dye represented by Formula (2).

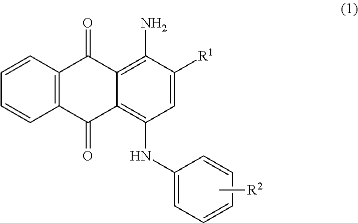

(In the above Formula (1), R¹ represents H or CH₃, and R² represents H or CH₃.)

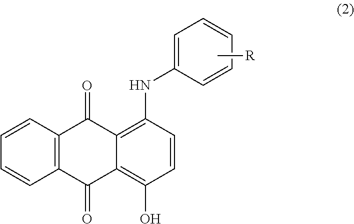

(In the above Formula (2), R represents H or CH₃.)

The sublimation dye ink jet black ink composition of the present embodiment contains these blue-based sublimation dyes and thus makes it possible to obtain a black image with a favorable, near-neutral hue.

The blue-based sublimation dye may also include other blue-based sublimation dyes. Examples of other blue-based sublimation dyes include C.I. Disperse Blue 359. However, it is preferable that these other sublimation dyes are not contained so as not to impair the black hue. In addition, in the case where these other sublimation dyes are contained, the content thereof is 1.0% by mass or less, more preferably 0.1% by mass or less, and still more preferably 0.01% by mass or less with respect to the total amount of the sublimation dye ink jet black ink composition.

### 1.1.2. Red-Based Sublimation Dye

The sublimation dye includes a red-based sublimation dye. The red-based sublimation dye is not particularly limited, and examples thereof include C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328, C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142, and C.I. Disperse Brown 1, 2, 4, 9, 13, 19, and 27.

Among the red-based sublimation dyes exemplified above, the sublimation dye ink jet black ink composition more preferably contains one or more selected from C.I. Disperse Red 60, C.I. Disperse Red 146, C.I. Disperse Orange 25, and C.I. Disperse Brown 27. As a result of selecting these sublimation dyes, a black image with a better hue can be formed.

### 1.1.3. Yellow-Based Sublimation Dye

The sublimation dye includes a yellow-based sublimation dye. The yellow-based sublimation dye is not particularly limited, and examples thereof include C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 116, 118, 119, 122, 124, 126, 135, 140, 141, 149, 160, 162, 164, 165, 179, 180, 182, 183, 184, 186, 192, 198, 199, 202, 204, 210, 211, 215, 216, 218, 224, 227, 231, 232, and 241.

Among the yellow-based sublimation dyes exemplified above, the sublimation dye ink jet black ink composition more preferably contains one or more selected from C.I. Disperse Yellow 54, C.I. Disperse Yellow 64, C.I. Disperse Yellow 211, and C.I. Disperse Yellow 241. As a result of selecting these sublimation dyes, a black image with a better hue can be formed.

### 1.1.4. Content, Etc.

The content of each of the blue-based sublimation dye, the red-based sublimation dye, and the yellow-based sublimation dye in the sublimation dye ink jet black ink composition is adjusted within a range in which black color is developed.

The content of the blue-based sublimation dye in the sublimation dye ink jet black ink composition is, for example, 0.5% by mass or more and 10% by mass or less, preferably 1% by mass or more and 8% by mass or less, more preferably 1% by mass or more and 6% by mass or less, and still more preferably 2% by mass or more and 5% by mass or less with respect to the total amount of the composition.

The content of the red-based sublimation dye in the sublimation dye ink jet black ink composition is, for example, 0.2% by mass or more and 4% by mass or less, preferably 0.5% by mass or more and 3% by mass or less, more preferably 1% by mass or more and 3% by mass or less, and still more preferably 1.5% by mass or more and 2.5% by mass or less with respect to the total amount of the composition.

The content of the yellow-based sublimation dye in the sublimation dye ink jet black ink composition is, for example, 0.2% by mass or more and 4% by mass or less, preferably 0.4% by mass or more and 2.5% by mass or less, more preferably 0.5% by mass or more and 2% by mass or less, and still more preferably 1% by mass or more and 2% by mass or less with respect to the total amount of the composition.

In addition, the content of the sublimation dye in the sublimation dye ink jet black ink composition, that is, the total content of the blue-based sublimation dye, the red-based sublimation dye, and the yellow-based sublimation dye, is preferably 2% by mass or more and 13% by mass or less, more preferably 5% by mass or more and 12% by mass or less, still more preferably 5.5% by mass or more and 11.5% by mass or less, and particularly preferably 6% by mass or more and 10% by mass or less with respect to the total amount of the composition. When the total content of the sublimation dye is within such a range, a black image with a better hue and higher density can be formed.

The ratio “Formula (1)/Formula (2)” of the sublimation dye represented by the above Formula (1) and the sublimation dye represented by the above Formula (2) (blue-based sublimation dyes) in the sublimation dye ink jet black ink composition is, on a mass basis, preferably 1/4 to 4/1, more preferably 1/3 to 3/1, still more preferably 1/2 to 2/1, and particularly preferably 1/1 to 1.5/1. When the mass ratio “Formula (1)/Formula (2)” is within such a range, a black image with a better hue can be obtained.

The sublimation dye may contain a sublimation dye corresponding to a complementary color. However, in the case where a sublimation dye corresponding to a complementary color is used, the content thereof is 0.1% by mass or less, more preferably 0.05% by mass or less, and still more preferably 0.01% by mass or less with respect to the total amount of the sublimation dye ink jet black ink composition so as not to impair the black hue.

### 1.2. Humectant

The sublimation dye ink jet black ink composition of the present embodiment contains a humectant. The humectant is not particularly limited, and examples thereof include water-soluble organic solvents which are liquid at room temperature and have a hydroxyl group, sugars which are solid at room temperature, sugar alcohols, and betaine compounds.

When a humectant is contained, while effectively suppressing the evaporation of moisture from the head during long-term standing, there is a tendency for the wettability on the recording medium to be enhanced, leading to further improved permeability of the sublimation dye ink jet black ink composition, and also for the ejection stability and the clogging recoverability to further improve. In particular, although an increase in the content of the sublimation dye is likely to reduce the ejection stability and the clogging recoverability, when a humectant is used in this case, its effect is more remarkably exhibited.

As water-soluble organic solvents, compounds used as water-soluble organic solvents in ordinary inks can be used, and specific examples thereof include polyols and betaine compounds.

Examples of polyols include polyhydric alcohols having two or more OH groups and glycol ethers having 2 or more and 6 or less carbon atoms in the molecule and optionally having one ether bond in the molecule. Specific examples of polyhydric alcohols having two or more OH groups include glycerin, diglycerin, ethylene glycol, diethylene glycol, triethylene glycol, propylene glycol, dipropylene glycol, 1,3-propanediol, 1,2-butanediol, 1,3-butanediol, 1,4-butanediol, 2,3-butanediol, 3-methyl-1,3-butanediol, 1,2-pentanediol, 1,5-pentanediol, 2-methyl-2,4-pentanediol, 3-methyl-1,5-pentanediol, 1,2-hexanediol, and 1,6-hexanediol. Preferred examples thereof include glycerin, diglycerin, propylene glycol, ethylene glycol, and 1,3-propanediol.

Examples of glycol ethers include monoalkyl ethers of glycols selected from ethylene glycol, diethylene glycol, triethylene glycol, propylene glycol, dipropylene glycol, and tripropylene glycol. More specifically, preferred examples thereof include triethylene glycol monomethyl ether, triethylene glycol monobutyl ether, and dipropylene glycol monopropyl ether.

The term “sugars” refers to monosaccharides, disaccharides, oligosaccharides (including trisaccharides and tetrasaccharides), and polysaccharides. Examples of sugars include glycerin, diglycerin, maltitol, lactitol, tetritol, pentitol, hexitol, erythritol, sorbitol, xylitol, mannitol, inositol, threose, erythrulose, erythrose, arabinose, ribulose, ribose, xylose, xylulose, lyxose, glucose, fructose, mannose, idose, sorbose, gulose, talose, tagatose, galactose, allose, psicose, altrose, maltose, isomaltose, cellobiose, lactose, sucrose, trehalose, isotrehalose, gentiobiose, melibiose, turanose, sophorose, isosucrose, homoglycans such as glucan, fructan, mannan, xylan, galacturonan, mannuronan, and N-acetylglucosamine polymers, heteroglycans such as diheteroglycan and triheteroglycan, maltotriose, isomaltotriose, panose, maltotetraose, and maltopentaose, and preferred examples thereof include trehalose, sorbitol, and xylitol.

A betaine compound is a compound that has a positive charge and a negative charge at non-adjacent positions within the same molecule, has no dissociable hydrogen atom bonded to an atom having a positive charge, and has no charge on the molecule as a whole (intramolecular salt). Preferred betaine compounds are N-alkyl-substituted amino acids, and N-trialkyl-substituted amino acids are more preferable. Examples of betaine compounds include trimethylglycine (also referred to as “glycine betaine”), γ-butyrobetaine, homarine, trigonelline, carnitine, homoserine betaine, valine betaine, lysine betaine, ornithine betaine, alanine betaine, stachydrine, and betaine glutamate, and preferred examples thereof include trimethylglycine.

The total content of the humectant is preferably 1% by mass or more and 40% by mass or less, more preferably 5% by mass or more and 30% by mass or less, and still more preferably 10% by mass or more and 20% by mass or less with respect to the total amount of the sublimation dye ink jet black ink composition. When the content of the humectant is within the range described above, while effectively suppressing the evaporation of moisture from the head during long-term standing, there is a tendency for the wettability on the intermediate transfer medium to be enhanced, leading to more excellent permeability of the sublimation dye ink jet black ink composition, and also for the ejection stability and the clogging recoverability to further improve.

In addition, it is more preferable that a polyol having three or more OH groups is contained as a humectant. Examples of such polyol compounds include glycerin, diglycerin, sugars, and sugar alcohols, and examples of sugars include sorbitol and trehalose.

Further, when a polyol having three or more OH groups is contained as a humectant, the total content thereof is preferably 3% by mass or more, more preferably 4% by mass or more, still more preferably 5% by mass or more, and particularly preferably 6% by mass or more. As a result of this, the clogging recoverability of the sublimation dye ink jet black ink composition can be further improved.

### 1.3. Water

The sublimation dye ink jet black ink composition contains water. The water is not particularly limited, but it is preferable to use, for example, pure water such as ion-exchanged water, ultrafiltered water, reverse osmosis water, or distilled water, or ultrapure water. In particular, water obtained by sterilizing such water by ultraviolet irradiation, hydrogen peroxide addition, or the like is preferable because the generation of mold and bacteria is further suppressed over a long period of time.

When the sublimation dye ink jet black ink composition contains water, the viscosity and the surface tension can be adjusted to fall within preferred ranges, and the ejection properties by the ink jet method can be made excellent. In addition, water is a component that can be easily removed after ejection by the ink jet method, and thus is important also for enhancing the productivity of the recorded matter. In addition, water is a substance that is highly safe for the human body and the like, and thus is preferable also for ensuring the safety of workers in the production of a dyed article.

The content of water is preferably 50% by mass or more and 95% by mass or less, more preferably 60% by mass or more and 90% by mass or less, and still more preferably 65% by mass or more and 85% by mass or less with respect to the total amount of the sublimation dye ink jet black ink composition.

### 1.4. Other Components

### Dispersant

The sublimation dye ink jet black ink composition may contain a dispersant. When the sublimation dye ink jet black ink composition contains a dispersant, the dispersion stability of the sublimation dye (disperse dye) in the sublimation dye ink jet black ink composition tends to be more excellent, and the storage stability of the sublimation dye ink jet black ink composition, the long-term ejection stability of the sublimation transfer ink, and the like tend to be more excellent. The dispersant is not particularly limited, and examples thereof include an anionic dispersant, a nonionic dispersant, and a polymer dispersant.

The anionic dispersant is not particularly limited, and examples thereof include a salt (e.g., a sodium salt; the same applies hereinafter) or formalin condensate of aromatic sulfonic acid, a salt or formalin condensate of β-naphthalene sulfonic acid, a salt or formalin condensate of an alkylnaphthalene sulfonic acid, and a salt or formalin condensate of creosote oil sulfonic acid.

The aromatic sulfonic acid is not particularly limited, and examples thereof include creosote oil sulfonic acid, cresol sulfonic acid, phenol sulfonic acid, β-naphthol sulfonic acid, alkylnaphthalene sulfonic acids such as methylnaphthalene sulfonic acid, and butylnaphthalene sulfonic acid, a mixture of β-naphthalene sulfonic acid and β-naphthol sulfonic acid, a mixture of a cresol sulfonic acid and 2-naphthol-6-sulfonic acid, and lignin sulfonic acid.

The nonionic dispersant is not particularly limited, and examples thereof include an ethylene oxide adduct of phytosterol and an ethylene oxide adduct of cholestanol.

The polymer dispersant is not particularly limited, and examples thereof include polyacrylic acid partial alkyl esters, polyalkylene polyamines, polyacrylic acid salts, styrene-acrylic acid copolymers, and vinylnaphthalene-maleic acid copolymers.

In the case where a dispersant is used in the sublimation dye ink jet black ink composition, the content of the dispersant with respect to the total amount of the sublimation dye contained is 1% by mass or more and 200% by mass or less, more preferably 50% by mass or more and 150% by mass or less. When the content of the dispersant is within the above range, the dispersion stability of the dye tends to further improve.

### Surface Tension Adjuster

The sublimation dye ink jet black ink composition may contain a surface tension adjuster. Examples of surface tension adjusters include surfactants, and examples thereof include various anionic surfactants, amphoteric surfactants, cationic surfactants, and nonionic surfactants.

Examples of anionic surfactants include alkyl sulfocarboxylates, α-olefin sulfonates, polyoxyethylene alkyl ether acetates, N-acyl amino acids and their salts, N-acylmethyl taurates, alkyl sulfate polyoxyalkyl ether sulfates, alkyl sulfate polyoxyethylene alkyl ether phosphates, rosin soaps, castor oil sulfate esters, lauryl alcohol sulfate esters, alkylphenol-type phosphate esters, alkyl-type phosphate esters, alkylaryl sulfonates, diethyl sulfosuccinates, diethylhexyl sulfosuccinates, and dioctyl sulfosuccinates.

Examples of amphoteric surfactants include lauryl dimethylaminoacetic acid betaine, 2-alkyl-N-carboxymethyl-N-hydroxyethyl imidazolinium betaine, coconut oil fatty acid amidopropyl dimethylaminoacetic acid betaine, polyoctyl polyaminoethyl glycine, and other imidazoline derivatives.

Examples of cationic surfactants include 2-vinylpyridine derivatives and poly(4-vinylpyridine) derivatives.

Examples of nonionic surfactants include ether-based surfactants such as polyoxyethylene nonylphenyl ether, polyoxyethylene octylphenyl ether, polyoxyethylene dodecylphenyl ether, polyoxyethylene oleyl ether, polyoxyethylene lauryl ether, and polyoxyethylene alkyl ether; ester-based surfactants such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; and acetylene glycol (alcohol)-based surfactants such as 2,4,7,9-tetramethyl-5-decyne-4,7-diol, 3,6-dimethyl-4-octyne-3,6-diol, and 3,5-dimethyl-1-hexyn-3-ol.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (which are all trade names, manufactured by Air Products Japan, K.K.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (which are all trade names, manufactured by Nissin Chemical Industry Co., Ltd.), and ACETYLENOL E00, E00P, E40, and E100 (which are all trade names, manufactured by Kawaken Fine Chemicals Co., Ltd.).

As a fluorine-based surfactant, a fluorine-modified polymer is preferably used, and specific examples thereof include BYK-340 (trade name, manufactured by BYK Japan KK).

The silicone-based surfactant is not particularly limited, and examples thereof preferably include a polysiloxane-based compound. The polysiloxane-based compound is not particularly limited, and examples thereof include polyether-modified organosiloxanes. Examples of commercially available products of the polyether-modified organosiloxanes include BYK-306, BYK-307, BYK-333, BYK-341, BYK-345, BYK-346, and BYK-348 (which are all trade names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (which are all trade names, manufactured by Shin-Etsu Chemical Co., Ltd.), and SILFACE SAG503A and SILFACE SAG014 (which are both trade names, manufactured by Nissin Chemical Industry Co., Ltd.).

One of the surfactants may be used alone, and it is also possible to use two or more kinds together.

In the case where the sublimation dye ink jet black ink composition contains a surfactant, the content thereof is preferably 0.1% by mass or more and 1.5% by mass or less, more preferably 0.5% by mass or more and 1% by mass or less, with respect to the total amount of the composition.

### Other Additives

The sublimation dye ink jet black ink composition may further contain, if necessary, antiseptic and antifungal agents, antioxidants, ultraviolet absorbers, chelating agents, oxygen absorbers, pH adjusters (e.g., triethanolamine, adipic acid, and potassium hydroxide), dissolution aids, and other various additives that can be used in ordinary inks. One of the various additives may be used alone, and it is also possible to use two or more kinds together.

Examples of antiseptic and antifungal agents include organic sulfur-based, organic nitrogen sulfur-based, organic halogen-based, haloallyl sulfone-based, iodopropargyl-based, N-haloalkylthio-based, benzothiazole-based, nitrile-based, pyridine-based, 8-oxyquinoline-based, isothiazolin-based, dithiol-based, pyridine oxide-based, nitropropane-based, organotin-based, phenol-based, quaternary ammonium salt-based, triazine-based, thiadiazine-based, anilide-based, adamantane-based, dithiocarbamate-based, brominated indanone-based, benzyl bromoacetate-based, and inorganic salt-based compounds. Examples of organic halogen-based compounds include sodium pentachlorophenol, examples of pyridine oxide-based compounds include sodium pyridinethione-1-oxide and zinc pyridinethione-1-oxide, and examples of isothiazoline-based compounds include amine salts of 1-benzisothiazolin-3-one, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, and 2-methyl-4-isothiazolin-3-one calcium chloride. Examples of other antiseptic and antifungal agents include sodium dehydroacetate, sodium sorbate, and sodium benzoate.

When the sublimation dye ink jet black ink composition contains a pH adjuster, the storage stability and the like of the sublimation dye ink jet black ink composition can be made particularly excellent. In addition, the reliability of the dyed article which is produced using the sublimation dye ink jet black ink composition can be made particularly excellent.

As the pH adjuster, for example, a pH adjuster which can control the pH of the sublimation dye ink jet black ink composition within a range of 6.0 or more and 11.0 or less can be suitably used. Examples of such pH adjusters include alkanolamines such as diethanolamine, triethanolamine, dimethylethanolamine, triisopropanolamine, and diethylethanolamine; hydroxides of alkali metals, such as lithium hydroxide, sodium hydroxide, and potassium hydroxide; ammonium hydroxide; carbonates of alkali metals, such as lithium carbonate, sodium carbonate, and potassium carbonate; and aminosulfonic acids such as taurine.

Examples of chelating agents include disodium ethylenediaminetetraacetate, sodium nitrilotriacetate, sodium hydroxyethylethylenediaminetriacetate, sodium diethylenetriaminepentaacetate, and sodium uracildiacetate.

Examples of rust inhibitors include acidic sulfite, sodium thiosulfate, ammonium thioglycolate, diisopropylammonium nitrite, pentaerythritol tetranitrate, dicyclohexylammonium nitrite, and benzotriazole-based compounds.

Examples of ultraviolet absorbers include benzophenone-based compounds, cinnamic acid-based compounds, triazine-based compounds, stilbene-based compounds, and so-called fluorescent brighteners (compounds that absorb ultraviolet light and emit fluorescence, represented by benzoxazole-based compounds).

Examples of antifoaming agents include highly oxidized oil-based compounds, glycerin fatty acid ester-based compounds, fluorine-based compounds, silicone-based compounds, and acetylene-based compounds.

### 1.5. Production and Physical Properties

From the viewpoint of further enhancing the ink jet image quality, the surface tension (static surface tension) at 20° C. of the sublimation dye ink jet black ink composition of the present embodiment is preferably 18 mN/m or more and 40 mN/m or less, more preferably 20 mN/m or more and 35 mN/m or less, and still more preferably 22 mN/m or more and 33 mN/m or less. The surface tension can be measured, for example, by confirming the surface tension of a platinum plate wetted with the ink jet ink composition in an environment at 20° C. using an automatic surface tensiometer CBVP-Z (trade name, manufactured by Kyowa Interface Science Co., Ltd.).

From the same viewpoint, the viscosity at 20° C. of the sublimation dye ink jet black ink composition is preferably 3 mPa·s or more and 10 mPa·s or less, and more preferably 3 mPa·s or more and 8 mPa·s or less. Regarding the measurement of viscosity, for example, the viscosity in an environment at 20° C. can be measured using a viscoelasticity tester MCR-300 (trade name, manufactured by Physica).

The sublimation dye ink jet black ink composition is obtained by mixing the components described above in any order and, if necessary, performing filtration or the like to remove impurities. As a method for mixing each component, a method in which materials are sequentially added to a container equipped with a stirring device such as a mechanical stirrer or a magnetic stirrer, and stirred and mixed, is suitably used. As a filtration method, centrifugal filtration, filter filtration, and the like can be performed if necessary.

### 1.6. Operational Effects, Etc.

According to the sublimation dye ink jet black ink composition of the present embodiment, a black image with an excellent hue can be formed.

### 2. Recording Method

A recording method according to the present embodiment includes an ink jet recording step of ejecting the sublimation dye ink jet black ink composition described above from an ink jet head and depositing the sublimation dye ink jet black ink composition onto a recording medium.

### 2.1. Recording Medium

The recording medium onto which the sublimation dye ink jet black ink composition is deposited by the recording method of the present embodiment is not particularly limited. Examples of recording media include an absorptive recording medium, a low-absorptive recording medium, and a non-absorptive recording medium.

Here, “low-absorptive recording medium” or “non-absorptive recording medium” refers to a recording medium in which the amount of water absorption from the start of contact to 30 msec is 10 mL/m² or less according to the Bristow method. The Bristow method is the most popular method as a method for measuring the amount of liquid absorption in a short time, and is also adopted by Japan Technical Association of the Pulp and Paper Industry (JAPAN TAPPI). Details of the test method are described in Standard No. 51 “Paper and Paperboard-Liquid Absorptivity Test Method-Bristow Method” of “JAPAN TAPPI Paper and Pulp Test Method 2000 Edition.”

The low-absorptive recording medium refers to a recording medium in which the amount of water absorption described above is 5 mL/m² or more and 10 mL/m² or less. On the other hand, the absorptive recording medium refers to a recording medium in which the amount of water absorption described above is more than 10 mL/m².

The absorptive recording medium is not particularly limited, and examples thereof include plain paper such as electrophotographic paper having high permeability to the ink composition, ink jet paper (ink jet dedicated paper having an ink-absorbing layer formed from silica particles or alumina particles, or an ink-absorbing layer formed from a hydrophilic polymer such as polyvinyl alcohol (PVA) or polyvinylpyrrolidone (PVP)), and fabrics.

The low-absorptive recording medium is not particularly limited, and examples thereof include coated paper provided with a coating layer for receiving an oil-based ink on the surface. The coated paper is not particularly limited, and examples thereof include printing text paper such as art paper, coated paper, and matte paper.

The non-absorptive recording medium is not particularly limited, and examples thereof include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced through the vapor deposition of these various metals, and plates of alloys such as stainless steel and brass; and recording media in which a plastic film such as polyvinyl chloride, polyethylene, polypropylene, polyethylene terephthalate (PET), polycarbonate, polystyrene, or polyurethane is bonded (applied) onto a substrate made of paper.

In the recording method of the present embodiment, the recording medium may be used as an intermediate transfer medium. Such a recording medium is not particularly limited, and examples thereof include paper (such as plain paper) and a recording medium provided with an ink-receiving layer (referred to as ink jet dedicated paper, coated paper, etc.). Among them, paper provided with an ink-receiving layer formed from inorganic fine particles such as silica is preferable. As a result, in the process in which the sublimation dye ink jet black ink composition deposited to the recording medium (intermediate transfer medium) dries, an intermediate transfer medium having a black image with a favorable hue can be obtained. In addition, as a result, in the process in which the sublimation dye ink jet black ink composition applied to the intermediate transfer medium dries, an intermediate recorded matter in which bleeding or the like on the recording surface is suppressed can be obtained. In addition, such a medium makes it easier to retain the sublimation dye on the surface of the recording surface, and in the case where a transfer step is included, the sublimation of the sublimation dye can be more efficiently performed.

### 2.2. Recording Step

In this step, the sublimation dye ink jet black ink composition is applied to the recording surface of the intermediate transfer medium (first recording medium) using an ink jet method. The ejection of the sublimation dye ink jet black ink composition by the ink jet method can be performed using a liquid droplet ejection apparatus (e.g., the ink jet recording apparatus described below).

As a liquid droplet ejection method (a method used in the ink jet method), a piezoelectric method, a method in which the ink is ejected using bubbles generated by heating the ink, or the like can be used, and the piezoelectric method is preferable from the viewpoint that, for example, the ink composition is unlikely to deteriorate.

In this step, multiple types of ink jet ink compositions may be used. As a result, for example, an image expressing a wide variety of colors can be obtained.

### 2.3. Other Steps

### Transfer Step

The recording method of the present embodiment may include a transfer step. As a result, the image formed on the recording medium (intermediate transfer medium) can be transferred to an article to be dyed. The recording surface of the recording medium (intermediate transfer medium) to which the sublimation dye ink jet black ink composition has been applied is heated while being positioned to face the article to be dyed (the article to be dyed is disposed on the recording surface of the recording medium), and the sublimation dye constituting the sublimation dye ink jet black ink composition is transferred to the article to be dyed. As a result, a dyed article in which a fabric, an object having various shapes, or the like serves as the article to be dyed is obtained.

The heating temperature in this step is 150° C. or more and 220° C. or less, preferably 150° C. or more and 200° C. or less. As a result, sufficient energy for transferring the sublimation dye to the article to be dyed can be applied, and the productivity of the dyed article can be made excellent.

The heating time in this step depends on the heating temperature, but is 30 seconds or more and 90 seconds or less, preferably 45 seconds or more and 60 seconds or less. As a result, sufficient energy for transferring the sublimation dye to the article to be dyed can be obtained, and the productivity of the dyed article can be made particularly excellent.

In addition, this step may be performed by heating the intermediate transfer medium to which the sublimation dye ink jet ink composition has been applied while the intermediate transfer medium is positioned to face the article to be dyed, but it is more preferable to perform the step by heating the intermediate transfer medium and the article to be dyed while they are in close contact with each other. This allows for, for example, dyeing with a clearer image.

As the article to be dyed, for example, a sheet-like object such as a fabric (fiber fabric, etc.) or a resin (plastic) film is suitably used, but a non-sheet-like object having a three-dimensional shape, such as a spherical shape or a rectangular parallelepiped shape, may also be used.

In addition, as the article to be dyed, for example, not only an object made of resin or plastic but also glass, metal, or ceramic may be used. Examples of fibers constituting the fabric as the article to be dyed include polyester fibers, nylon fibers, triacetate fibers, diacetate fibers, polyamide fibers, and blended products using two or more types of these fibers. In addition, a blended product of them with regenerated fibers such as rayon or natural fibers such as cotton, silk, and wool may also be used.

In addition, examples of resin (plastic) films to serve as the article to be dyed include polyester films, polyurethane films, polycarbonate films, polyphenylene sulfide films, polyimide films, and polyamide-imide films. The resin (plastic) film may be a laminate in which a plurality of layers are laminated, or may be formed of a gradient material in which the composition of the material changes in a gradient manner.

### Peeling Step

The recording method of the present embodiment may include a peeling step. In this step, the recording medium (intermediate transfer medium) is peeled off from the object to be dyed (article to be dyed) after the image is transferred in the transfer step. The peeling technique is not particularly limited, and the peeling can be performed by using an appropriate apparatus or by a manual technique.

According to the ink jet recording method of the present embodiment, a dyed article having a black image with an excellent hue can be obtained.

### 3. Ink Jet Recording Apparatus

The sublimation dye ink jet black ink composition described above can be suitably used in an ink jet recording apparatus. The ink jet recording apparatus is not particularly limited as long as it includes at least an ink storage container (cartridge, tank, etc.) that stores the sublimation transfer ink jet black ink composition and a recording head connected thereto, and is capable of ejecting the sublimation dye ink jet black ink composition from the recording head to form an image on an intermediate transfer medium (transfer paper, etc.).

As the ink jet recording apparatus of the present embodiment, either a serial type or a line type can be used. In these types of ink jet recording apparatuses, a recording head is mounted. While changing the relative positional relationship between the recording medium (intermediate transfer medium) and the recording head, liquid droplets of the ink composition are ejected from a nozzle hole of the recording head at a predetermined timing (intermittently) and in a predetermined volume (mass) to deposit the ink jet ink composition onto the recording medium (intermediate transfer medium), whereby a predetermined image can be formed.

Here, generally, in a serial-type ink jet recording apparatus, the transport direction of the recording medium and the direction of the reciprocating motion of the recording head intersect each other, and the relative positional relationship between the recording medium and the recording head is changed by a combination of the reciprocating motion of the recording head and the transport motion (including reciprocating motion) of the recording medium. In addition, in this case, generally, a plurality of nozzle holes (holes for ejecting the ink composition) are arranged in the recording head, and a row of nozzle holes (nozzle array) is formed along the transport direction of the recording medium. In addition, depending on the type and number of ink compositions, a plurality of nozzle arrays may be formed in the recording head.

In addition, generally, in a line-type ink jet recording apparatus, the recording head does not perform reciprocating motion, and the relative positional relationship between the recording medium and the recording head is changed by transporting the recording medium. Also in this case, generally, a plurality of nozzle holes are arranged in the recording head, and a row of the nozzle holes (nozzle array) is formed along a direction intersecting the transport direction of the recording medium.

The ink jet recording method uses a serial-type or line-type ink jet recording apparatus, and the method is not particularly limited as long as the ink composition can be ejected as liquid droplets from fine nozzle holes, and the liquid droplets can be attached to a recording medium. For example, as a liquid droplet ejection method (a method used in the ink jet method), a piezoelectric method, a method in which the ink is ejected using bubbles generated by heating the ink, or the like can be used, and the piezoelectric method is preferable from the viewpoint that, for example, the ink composition is unlikely to deteriorate.

In the ink jet recording apparatus used in the present embodiment, for example, known configurations such as a heating unit, a drying unit, a roll unit, and a winding device may be employed without limitation.

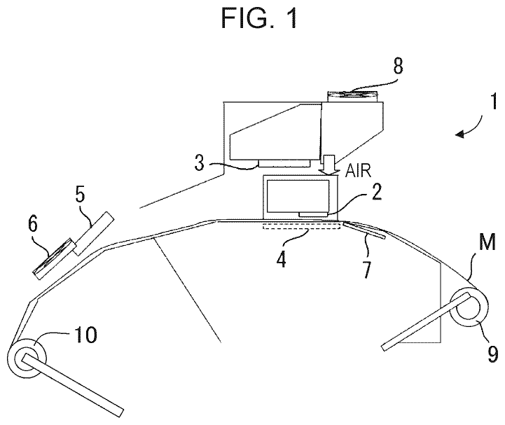

Hereinafter, an example of a recording apparatus suitable for the ink jet recording method of the present embodiment will be described. FIG. 1 is a schematic sectional view of an ink jet recording apparatus according to one embodiment. As shown in FIG. 1, the recording apparatus 1 includes a supply roll 9, a recording head 2, an IR heater 3, a platen heater 4, an afterheater 5, a cooling fan 6, a preheater 7, a ventilation fan 8, and a winding roll 10.

The recording head 2 ejects a sublimation dye ink jet black ink composition onto a recording medium M (intermediate transfer medium) fed from the supply roll 9. As the recording head 2, a known method can be used. Examples of known methods include those that eject liquid droplets utilizing the vibration of a piezoelectric element, such as a head that forms ink droplets through the mechanical deformation of an electrostrictive element. For example, the recording head 2 can eject dots of the sublimation dye ink jet black ink composition in multiple sizes from a single nozzle.

In the drying step, the recording medium (intermediate transfer medium) is heated after the recording step. In the recording apparatus 1, this step can be performed by the afterheater 5. In addition, although not illustrated, a hot air mechanism (not illustrated), a thermostatic bath (not illustrated), and the like may also be used. The afterheater 5 heats and dries the recording medium (intermediate transfer medium) to which the sublimation dye ink jet black ink composition has been deposited. The afterheater 5 heats the recording medium (intermediate transfer medium) on which an image has been recorded, thereby allowing moisture and the like contained in the sublimation dye ink jet black ink composition to evaporate and scatter more quickly, and thus suppressing bleeding and the like. The afterheater 5 heats the recording medium (intermediate transfer medium) preferably to 50° C. or more, and still more preferably to 60° C. or more and 110° C. or less.

In addition, the recording apparatus 1 includes the IR heater 3, which directly heats the recording head 2, and the platen heater 4, which heats the recording head 2 via the recording medium (intermediate transfer medium).

When the IR heater 3 is used, the recording medium (intermediate transfer medium) can be heated also from the recording head 2 side. As a result, the recording head 2 is likely to be heated at the same time. However, compared with the case where the recording medium (intermediate transfer medium) is heated from the back side, such as by the platen heater 4, the temperature can be raised without being affected by the thickness of the recording medium (intermediate transfer medium). In addition, when the platen heater 4 is used, the recording medium (intermediate transfer medium) can be heated from the side opposite to the recording head 2 side. As a result, the recording head 2 is relatively unlikely to be heated.

The above expression “heating the recording medium (intermediate transfer medium)” refers to increasing the temperature of the recording medium (intermediate transfer medium) to a desired temperature, and is not limited to directly heating the recording medium (intermediate transfer medium). The recording apparatus 1 may have the cooling fan 6. When the ink composition on the recording medium (intermediate transfer medium) is cooled by the cooling fan 6 after drying, there is a tendency that a coating film can be formed on the recording medium (intermediate transfer medium) with good adhesion.

In addition, the recording apparatus 1 may include the preheater 7 that heats (preheats) the recording medium (intermediate transfer medium) in advance before the ink composition is ejected onto the recording medium (intermediate transfer medium). Further, the recording apparatus 1 may include the ventilation fan 8 so that the ink composition deposited to the recording medium (intermediate transfer medium) dries more efficiently.

The recording medium M (intermediate transfer medium) on which recording has been performed and which has undergone the drying step is wound by the winding roll 10. The recording apparatus 1 does not necessarily have the winding roll 10. For example, the recording medium M (intermediate transfer medium) that has undergone a drying step may be transported to a non-illustrated transfer device and subjected to a transfer step and a peeling step.

### 4. Examples and Comparative Examples

Hereinafter, the present disclosure will be specifically described with reference to examples, but the present disclosure is not limited to these examples. Hereinafter, “part” and “%” are on a mass basis unless otherwise specified. Unless otherwise specified, the evaluation was performed in an environment at a temperature of 25° C. and a relative humidity of 40.0%.

### 4.1. Preparation of Inks

For the ink of each example shown in Tables 1 and 2, the components are put into a container so as to achieve the composition shown in the table, followed by mixing and stirring for 2 hours using a magnetic stirrer. The mixture is then filtered through a membrane filter having a pore size of 5 μm, thereby giving the inks (sublimation dye ink jet black ink compositions) of Examples 1 to 18 and Comparative Examples 1 to 3. The numerical values in the table represent % by mass.

In Tables 1 and 2, SILFACE SAG503A represents a silicone-based surfactant (manufactured by Nissin Chemical Co., Ltd.). In the description of dyes, the notation “C.I.” (abbreviation for Color Index) is omitted. In addition, for surfactants and dye dispersions, the amount of active ingredient is indicated.

In Tables 1 and 2, the following sublimation dyes are used.
Sublimation dye 1-1 (Formula (1) wherein R¹═H, R²═H) (15 parts), DISPERBYK-2015 (manufactured by BYK Japan Co., Ltd., 18.75 parts, dispersant), BYK-1770 (manufactured by BYK Japan Co., Ltd., 0.05 parts, defoaming agent), and pure water (66.2 parts) were mixed and stirred to prepare a liquid mixture. Zirconia beads (1 mm) and the liquid mixture are put into a 100-ml container, and the container is set in a rocking mill RM-05 (manufactured by Seiwa Giken Co., Ltd.). A dispersion treatment is performed for 4 hours to obtain a treatment liquid. A mesh filter #100 is attached to the container, and the treatment liquid is filtered. Thereafter, zirconia beads (0.1 mm) and the treatment liquid are put into a 100-ml container, and the container is set in a rocking mill RM-05 (manufactured by SEIWA GIKEN Co., Ltd.). A dispersion treatment is performed for 4 hours to obtain a dispersion. A mesh filter #400 is attached to the container, and the dispersion is filtered to prepare a dispersion. Also for other dyes, dispersions of sublimation dye 1-2 (Formula (1) wherein R¹═CH₃, R²═CH₃), sublimation dye 2-1 (Formula (2) wherein R═CH₃), sublimation dye 2-2 (Formula (2) wherein R═H), red-based sublimation dyes, yellow-based sublimation dyes, and other sublimation dyes are prepared by the same operation.

### 4.2. Evaluation Method

### 4.2.1. Evaluation of Hue

PX-G930 (ink jet printer, manufactured by Seiko Epson Corporation) is filled with an ink described in Table 3, and a solid pattern is printed on a sublimation transfer paper EPSON DS Transfer Multi-Purpose (manufactured by Seiko Epson Corporation) such that the ink deposition amount is 11 mg/inch². Thereafter, using a desktop automatic sublimation transfer press AF-54TEN (manufactured by ITSUMI Inc.), the image is transferred onto a 100% polyester fabric CARL DRY (manufactured by Toray Industries, Inc.) under pressure at a temperature of 200° C. for 40 seconds (465 g/cm²). After transfer, the color of the fabric is measured with a colorimeter i1PRO3 (manufactured by X-Rite Inc.). Evaluation is made according to the following criteria, and the results are shown in Table 3.
A: The hue angle ∠H° defined in the CIELAB color space is within a range of 320° or more and 360° or less.
B: The hue angle ∠H° defined in the CIELAB color space is within a range of 300° or more and less than 320° or within a range of more than 0° and 10° or less.
C: The hue angle ∠H° defined in the CIELAB color space is outside the ranges A and B.

### 4.2.2. Evaluation of Black Density

PX-G930 (ink jet printer, manufactured by Seiko Epson Corporation) is filled with an ink described in Table 3, and a solid pattern is printed on a sublimation transfer paper EPSON DS Transfer Multi-Purpose (manufactured by Seiko Epson Corporation) such that the ink deposition amount is 11 mg/inch². Thereafter, using a desktop automatic sublimation transfer press AF-54TEN (manufactured by ITSUMI Inc.), the image is transferred onto a 100% polyester fabric CARL DRY (manufactured by Toray Industries, Inc.) under pressure at a temperature of 200° C. for 40 seconds (465 g/cm²). After transfer, the color of the fabric is measured with a colorimeter i1PRO3 (manufactured by X-Rite Inc.). Evaluation is made according to the following criteria, and the results are shown in Table 3.
A: OD value is 1.45 or more.
B: OD value is 1.4 or more and less than 1.45.
C: OD value is less than 1.4.

### 4.2.3. Evaluation of Clogging Recoverability

An ink jet printer (trade name PX-G930, manufactured by Seiko Epson Corporation) is filled with the ink composition of each example, and left to stand for 20 minutes with the head cap of the ink cartridge open. Thereafter, cleaning is performed once, a solid pattern is printed on 20 sheets, and then a nozzle check pattern is printed to inspect the nozzles for misfiring and misdirection. The test environment is at a temperature of 40° C. and a humidity of 20%. Evaluation is made according to the following criteria, and the results are shown in Table 3.
A: Of the 180 nozzles, the number of nozzles with misfiring or misdirection is 0.
B: Of the 180 nozzles, the number of nozzles with misfiring or misdirection is 1 to 30.
C: Of the 180 nozzles, the number of nozzles with misfiring or misdirection is 31 to 180.

### 4.3. Evaluation Results

As can be seen from the table, the sublimation dye ink jet black ink compositions of the examples, each containing a sublimation dye, a humectant, and water, in which the sublimation dye includes a blue-based sublimation dye, a red-based sublimation dye, and a yellow-based sublimation dye, and the blue-based sublimation dye includes a sublimation dye represented by Formula (1) and a sublimation dye represented by Formula (2), all have a favorable hue.

The present disclosure includes configurations substantially the same as the configurations described in the embodiment, for example, configurations having the same function, method, and result, or configurations having the same purpose and effect. In addition, the present disclosure includes configurations in which non-essential parts of the configurations described in the embodiment are replaced. In addition, the present disclosure includes configurations that produce the same effects or configurations that can achieve the same objects as those of the configurations described in the embodiment. In addition, the present disclosure includes configurations in which a known technique is added to the configurations described in the embodiment.

The following contents are derived from the embodiments and modification examples described above.

The sublimation dye ink jet black ink composition contains a sublimation dye, a humectant, and water, in which the sublimation dye includes a blue-based sublimation dye, a red-based sublimation dye, and a yellow-based sublimation dye, and the blue-based sublimation dye includes a sublimation dye represented by Formula (1) and a sublimation dye represented by Formula (2).

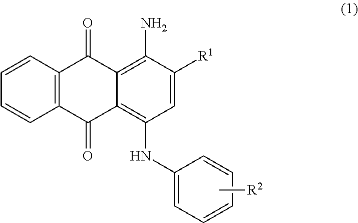

(In the above Formula (1), R¹ represents H or CH₃, and R² represents H or CH₃.)

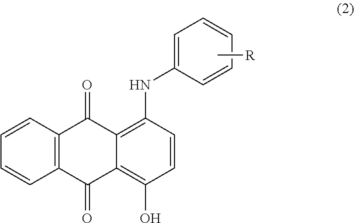

(In the above Formula (2), R represents H or CH₃.)

According to this sublimation dye ink jet black ink composition, a black image with an excellent hue can be formed.

In the sublimation dye ink jet black ink composition, the content of the sublimation dye may be 5.5% by mass or more and 11.5% by mass or less with respect to the total amount of the composition.

According to this sublimation dye ink jet black ink composition, a black image with a better hue and higher density can be formed.

In the sublimation dye ink jet black ink composition, the red-based sublimation dye may include one or more selected from C.I. Disperse Red 60, C.I. Disperse Red 146, C.I. Disperse Orange 25, and C.I. Disperse Brown 27.

According to this sublimation dye ink jet black ink composition, a black image with a better hue can be formed.

In the sublimation dye ink jet black ink composition, the yellow-based sublimation dye may include one or more selected from C.I. Disperse Yellow 54, C.I. Disperse Yellow 64, C.I. Disperse Yellow 211, and C.I. Disperse Yellow 241.

According to this sublimation dye ink jet black ink composition, a black image with a better hue can be formed.

In the sublimation dye ink jet black ink composition, a ratio “Formula (1)/Formula (2)” of the sublimation dye represented by Formula (1) to the sublimation dye represented by Formula (2) may be 1/3 to 3/1 on a mass basis.

According to this sublimation dye ink jet black ink composition, a black image with a better hue can be obtained.

In the sublimation dye ink jet black ink composition, as the humectant, 5% by mass or more of a polyol having three or more OH groups may be contained.

According to this sublimation dye ink jet black ink composition, the clogging recoverability can be further improved.

The recording method includes an ink jet recording step of ejecting any one of the sublimation dye ink jet black ink compositions described above from an ink jet head and depositing the sublimation dye ink jet black ink composition onto a recording medium.

According to this recording method, a black image with an excellent hue can be formed.

The recording method may further include a transfer step of superimposing a recording surface of the recording medium on an object to be dyed, followed by heating at a temperature of 150° C. or more and 200° C. or less, thereby sublimating and transferring an image onto the object to be dyed.

According to this recording method, a black transfer image with an excellent hue can be formed.

The recording method may further include a peeling step of peeling the recording medium from the object to be dyed after the transfer step.

According to this recording method, a black transfer image with an excellent hue can be formed.

What is claimed is:

1. A sublimation dye ink jet black ink composition comprising:
a sublimation dye;
a humectant; and
water, wherein
the sublimation dye includes a blue-based sublimation dye, a red-based sublimation dye, and a yellow-based sublimation dye, and
the blue-based sublimation dye includes a sublimation dye represented by Formula (1) and a sublimation dye represented by Formula (2): 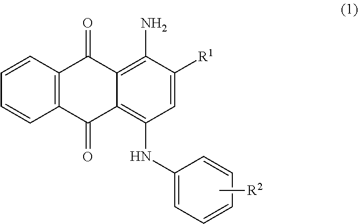
wherein R¹ represents H or CH₃, and R² represents H or CH₃; 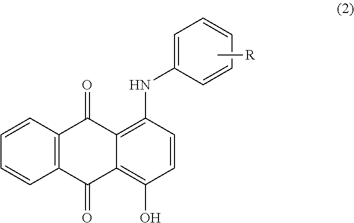
wherein R represents H or CH₃.

2. The sublimation dye ink jet black ink composition according to claim 1, wherein
a content of the sublimation dye is 5.5% by mass or more and 11.5% by mass or less with respect to a total amount of the composition.

3. The sublimation dye ink jet black ink composition according to claim 1, wherein
the red-based sublimation dye includes one or more selected from C.I. Disperse Red 60, C.I. Disperse Red 146, C.I. Disperse Orange 25, and C.I. Disperse Brown 27.

4. The sublimation dye ink jet black ink composition according to claim 1, wherein
the yellow-based sublimation dye includes one or more selected from C.I. Disperse Yellow 54, C.I. Disperse Yellow 64, C.I. Disperse Yellow 211, and C.I. Disperse Yellow 241.

5. The sublimation dye ink jet black ink composition according to claim 1, wherein
a ratio Formula (1)/Formula (2) of the sublimation dye represented by Formula (1) to the sublimation dye represented by Formula (2) is 1/3 to 3/1 on a mass basis.

6. The sublimation dye ink jet black ink composition according to claim 1, wherein
as the humectant, 5% by mass or more of a polyol having three or more OH groups is contained.

7. A recording method comprising ejecting the sublimation dye ink jet black ink composition according to claim 1 from an ink jet head and depositing the sublimation dye ink jet black ink composition onto a recording medium.

8. The recording method according to claim 7, further comprising
superimposing a recording surface of the recording medium on an object to be dyed, followed by heating at a temperature of 150° C. or more and 200° C. or less, thereby sublimating and transferring an image onto the object to be dyed.

9. The recording method according to claim 8, further comprising
peeling the recording medium from the object to be dyed after the transferring.
